(19) United States
(12) Patent Application Publication
(10) Pub. No.: US 2010/0019104 A1
(43) Pub. Date: Jan. 28, 2010

(54) HYDRAULIC HOSE GUIDING DEVICE

(75) Inventors: Katsunori ICHIMURA, Ibaraki (JP); Takeshi MATSUDA, Ibaraki (JP); Nozomu TANAKA, Ibaraki (JP)

Correspondence Address: MATTINGLY & MALUR, P.C., 1800 DIAGONAL ROAD, SUITE 370, ALEXANDRIA, VA, 22314, US

(73) Assignee: HITACHI CONSTRUCTION CO., LTD., Tokyo (JP)

(21) Appl. No.: 12/482,581

(22) Filed: Jun. 11, 2009

(30) Foreign Application Priority Data
Jul. 25, 2008 (JP) 2008-192872

(51) Int. Cl. F16L 3/01

(52) U.S. Cl. 248/49

(57) ABSTRACT

A hydraulic hose guiding device allowing hydraulic hoses to be connected to an operational pattern switching valve in a construction machine with better operational efficiency is provided. The hydraulic hoses to be connected to the operational pattern switching valve are lead through a clearance between an operator's cab disposed on an upper revolving superstructure and a cooler chamber of a hydraulic power unit. A guide member that holds the plurality of hydraulic hoses neatly in place by preventing their displacement toward the cooler chamber is disposed between the operator's cab and the cooler chamber.

### TECHNICAL FIELD

The present invention relates to a hydraulic hose guiding device utilized in a construction machine such as a hydraulic excavator to guide a hydraulic hose connecting an operational pattern switching valve, a control valve and a pilot valve.

### BACKGROUND ART

The revolving motion of the upper revolving superstructure, the boom hoisting operation, the arm rotating operation and the bucket rotating operation in a hydraulic excavator are usually controlled by individually operating operation levers disposed on the left side and the right side of the operator's seat along the forward/backward direction and the left/right direction. The operational pattern defining how a specific actuator is engaged in operation along a specific direction by operating either the left-side operation lever or the right-side operation lever along a given direction differs from one hydraulic excavator manufacturer to another hydraulic excavator manufacturer. Thus arises a challenge in that an operator accustomed to operating a hydraulic excavator manufactured by one manufacturer needs to operate a hydraulic excavator manufactured by another manufacturer, equipped with operation levers adopting a different operational pattern, with extra care, which is bound to increase the operator's stress level and may lead to erroneous operation by a weary operator. This issue is addressed in, for instance, Japanese Laid Open Patent Publication No. 2001-90706 and Japanese Laid Open Patent Publication No. 2006-144296, each disclosing an operational pattern switching valve.

The operational pattern switching valve is disposed between operation chambers for the control valves via which a total of four actuators, i.e., the hydraulic cylinders for the revolving motor at the revolving device, the boom, the arm and the bucket are controlled, and four pilot valves each provided in conjunction with one of the control valves. Operational patterns can be switched via the operational pattern switching valve to select the ideal operational pattern for the specific operator.

### DISCLOSURE OF THE INVENTION

The operational pattern switching valve is disposed near a side of the upper revolving superstructure so as to enable the user to perform the switching operation with ease. In addition, while the operational pattern switching valve and the control valves at the upper revolving superstructure are normally connected via eight hydraulic hoses and the operational pattern switching valve and the pilot valves installed under the operator's cab are connected via eight hydraulic hoses, these hydraulic hoses are laid out through the clearance between the operator's cab and the cooler chamber in the hydraulic power unit.

In the hydraulic excavator assembly process, the hydraulic power unit is assembled and the piping is connected first and then the hydraulic hoses are connected to the ports of the operational pattern switching valve, since the hydraulic hose connection is a task that must be performed at a location near the side of the upper revolving superstructure. Namely, the joints at the front ends of the numerous hydraulic hoses placed between the cooler chamber and the operator's cab are connected to the corresponding ports at the operational pattern switching valve after a hydraulic fluid piping through which a hydraulic fluid to be cooled flows and a fuel hose, through which fuel to be cooled flows, are positioned between the cooler chamber where an oil cooler, a radiator, a fuel cooler and the like are installed, located near one end of the hydraulic power unit, i.e., near one side of the upper revolving superstructure, and the operator's cab.

Since the hydraulic hoses being connected to the operational pattern switching valve described above are still in a loose state, a hydraulic hose caught between hydraulic fluid pipes through which the hydraulic fluid to be cooled flows may become entangled or hinder the connecting work performed to connect the hydraulic hose to the operational pattern switching valve. In addition, any hydraulic hose misalignment occurring before connecting the hydraulic hoses to the operational pattern switching valve may hinder the connection work performed to connect the hydraulic hoses to the operational pattern switching valve. Since it is, therefore, necessary to connect the hydraulic hoses to the operational pattern switching valve with an operator holding the hydraulic hoses so as to ensure that they do not become caught between the hydraulic fluid pipes or the like, the level of work efficiency is compromised.

An object of the present invention, having been completed by addressing the issues discussed above, is to provide a hydraulic hose guiding device that improves the work efficiency with which hydraulic hoses are connected to the operational pattern switching valve.

1) The present invention provides a hydraulic hose guiding device in a construction machine having an operational pattern switching valve, operation chambers for control valves used to control plurality of hydraulic actuators, and pilot valves operated via operation levers installed on the left side and the right side of an operator's seat, which are connected through a plurality of hydraulic hoses installed between an operator's cab disposed on an upper revolving superstructure and a cooler chamber in a hydraulic power unit. The hydraulic hose guiding device is characterized in that a guide member, used to keep the plurality of hydraulic hoses neatly in place by preventing the hydraulic hoses from moving close toward the cooler chamber, is disposed between the operator's cab and the cooler chamber.

2) In addition, the guide member in the hydraulic hose guiding device according to the present invention may be constituted with a plate having a bolt through hole formed therein and a hydraulic hose guide rod passing through and locked onto the plate. The guide member may be held fast so as not to turn loosely by attaching the plate via mounting bolts onto a frame present on the upper revolving superstructure and inserting a lower portion of the rod through a hole formed in the frame.

According to the present invention, the hydraulic hoses are kept neatly in place by the guide member disposed between the cooler chamber and the operator's cab, so as to prevent the hydraulic hoses connected to the operational pattern switching valve from coming too close to the cooler chamber. As a result, the connection work performed to connect the hydraulic hoses to the operational pattern switching valve can be performed with ease by ensuring that the hydraulic hoses are held neatly in place without allowing any stray hose to become caught between hydraulic fluid pipes. At the same time, since the operator does not need to hold the hydraulic hoses in order to prevent the hydraulic hoses from shifting around, better operational efficiency is assured.

In addition, according to the present invention, the guide member constituted with a plate attached via a mounting bolt onto a frame on the upper revolving superstructure, and a rod disposed at the plate, the lower portion of which is inserted through a hole formed in the frame so as to disallow turning of the guide member, can be locked onto the frame with a high level of reliability.

### BRIEF DESCRIPTION OF THE DRAWINGS

FIG. 1 is a perspective of the upper superstructure in a hydraulic excavator equipped with the hydraulic hose guiding device according to the present invention;

FIG. 2 is a plan view showing part of the upper superstructure in FIG. 1;

FIG. 3 is a hydraulic circuit diagram presenting an example of a hydraulic circuit that may be assumed for an operational pattern switching valve that may be adopted in the present invention;

FIG. 4 illustrates how the left-side operation lever device and the right-side operation lever device in FIG. 3 may be operated along specific directions;

FIG. 5 is a perspective of an embodiment of the hydraulic hose guiding device according to the present invention;

FIG. 6 is a plan view showing part of FIG. 5;

FIG. 7 is a perspective showing how the guide member is mounted in the embodiment; and

FIG. 8 is a plan view illustrating the advantages achieved through the embodiment.

### BEST MODE FOR CARRYING OUT THE INVENTION

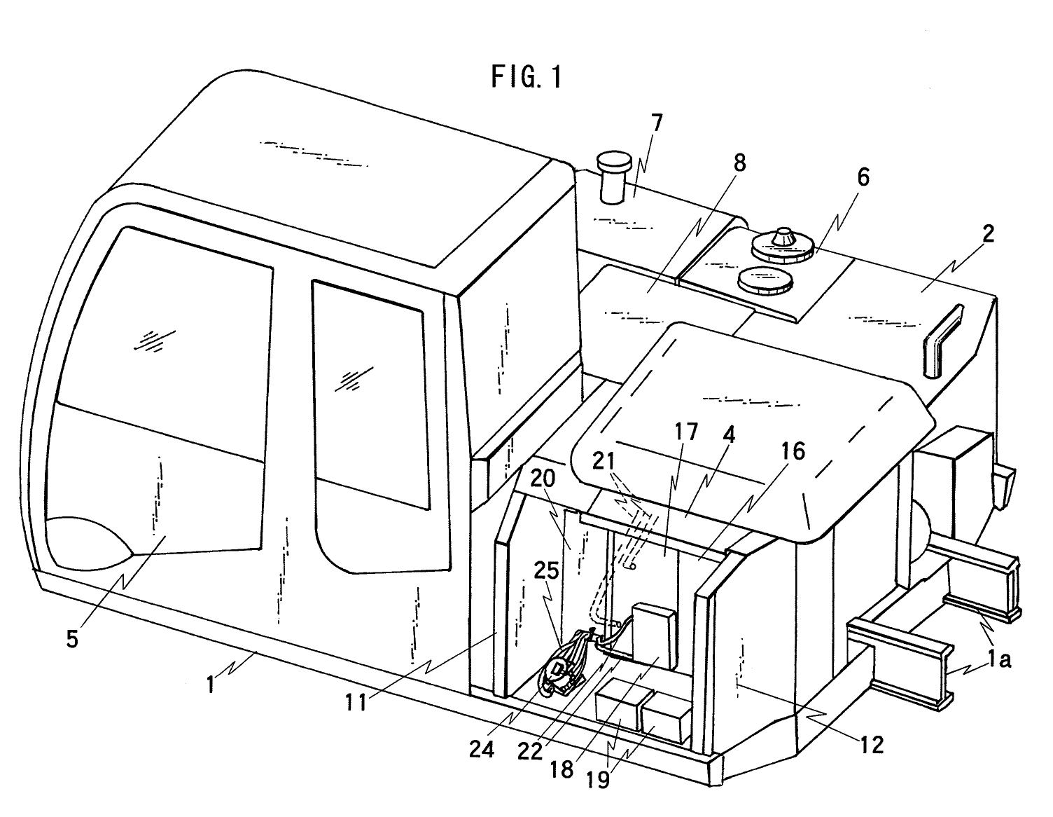

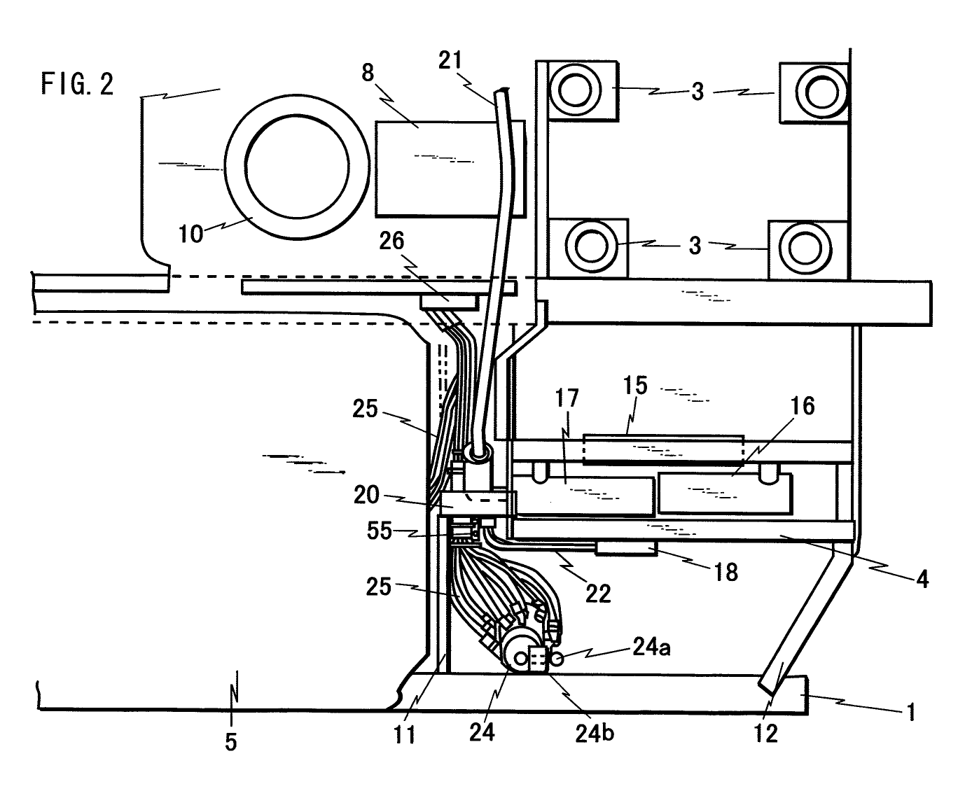

FIG. 1 is a perspective presenting an example of the upper superstructure in a hydraulic excavator that may include the guiding device according to the present invention, whereas FIG. 2 is a partial plan view of the upper superstructure. In FIGS. 1 and 2, reference numeral 1 indicates an upper revolving superstructure that is disposed on a lower traveling superstructure (not shown) via a revolving device (not shown) and reference numeral 1a indicates a mainframe of the upper revolving superstructure. Reference numeral 2 indicates a hydraulic power unit that includes an engine (not shown) installed on bases 3 and a cooler chamber 4, reference numeral 5 indicates an operator's cab, reference numeral 6 indicates a hydraulic fluid tank, reference numeral 7 indicates a fuel tank and reference numeral 8 indicates a control valve device that includes a plurality of control valves shown in FIG. 2. They are all disposed on the upper revolving superstructure 1. Reference numeral 10 indicates a mounting unit at which the revolving device is installed. Reference numeral 11 indicates a front wall enclosing the hydraulic power unit 2 and reference numeral 12 indicates a rear wall also enclosing the hydraulic power unit, with a door (not shown) mounted between the front wall and the rear wall. While a counterweight is attached to the rear end of the main frame 1a of the upper revolving superstructure 1, the illustrations in the figures do not include the counterweight.

A suction fan 15, a radiator 16, an oil cooler 17 that cools the hydraulic fluid and a fuel cooler 18 are installed in the cooler chamber 4. Reference numeral 19 indicates batteries disposed between the cooler chamber 4 and a side of the upper revolving superstructure 1. Reference numeral 20 indicates a wall erected between the front wall 11 and the cooler chamber 4 so as to ensure that air drawn through the fan 15 does not enter the area between the cooler chamber 4 and the operator's cab 5. Reference numeral 21 indicates a hydraulic fluid piping connecting the oil cooler 17 and the hydraulic fluid tank 6, through which the hydraulic fluid to be cooled is supplied and discharged, whereas reference numeral 22 indicates a fuel hose connecting the fuel cooler 18 and the fuel tank 7, through which the fuel to be cooled is supplied and discharged. Two such hoses 21 and two such hoses 22 are installed and they are laid out through the clearance between the operator's cab 5 and the cooler chamber 4.

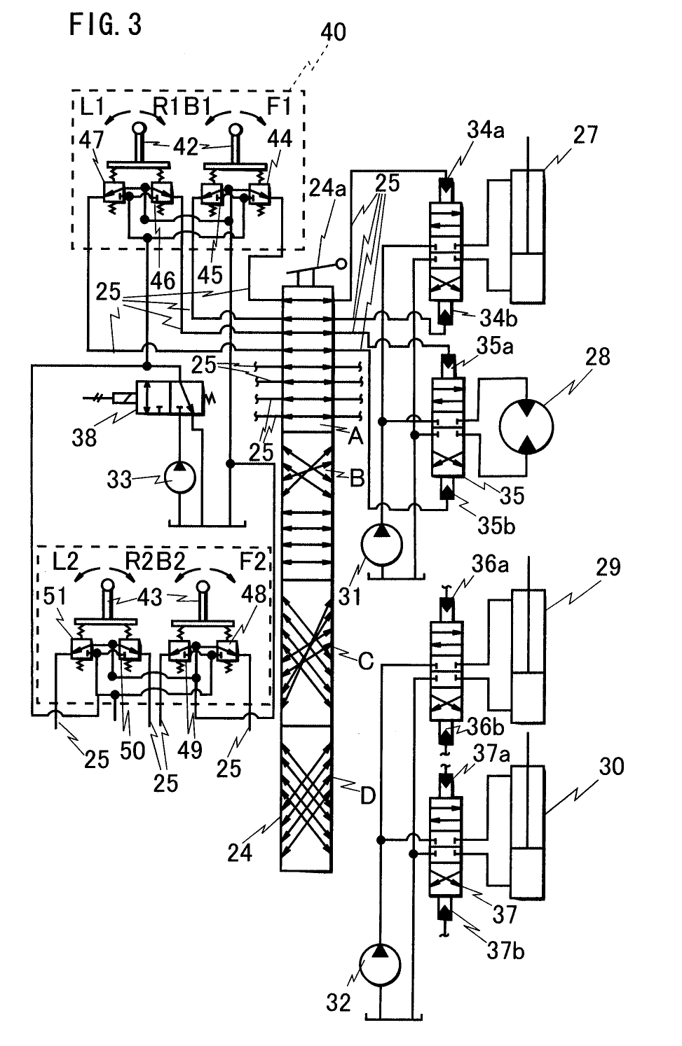

Reference numeral 24 indicates an operational pattern switching valve, and reference numeral 25 indicates hydraulic hoses connected to the operational pattern switching valve 24. In order to allow the user to operate an operation lever 24a with ease, the operational pattern switching valve 24 is installed in the rear of the operator's cab 5 above the upper revolving superstructure 1 and in the vicinity of a side of the upper revolving superstructure 1. Reference numeral 24b is a lock used to lock the operation lever 24a having been set at a specific position. A total of sixteen hydraulic hoses 25 are installed and eight hydraulic hoses among them are connected to a control valve device 8 through the clearance between the operator's cab 5 and the cooler chamber 4. The remaining eight hydraulic hoses are connected to a relay device 26 through the clearance between the operator's cab 5 and the cooler chamber 4 and further extend from the relay device 26 to be connected to pilot valves 44˜51 (see FIG. 3) installed under the operator's cab 5.

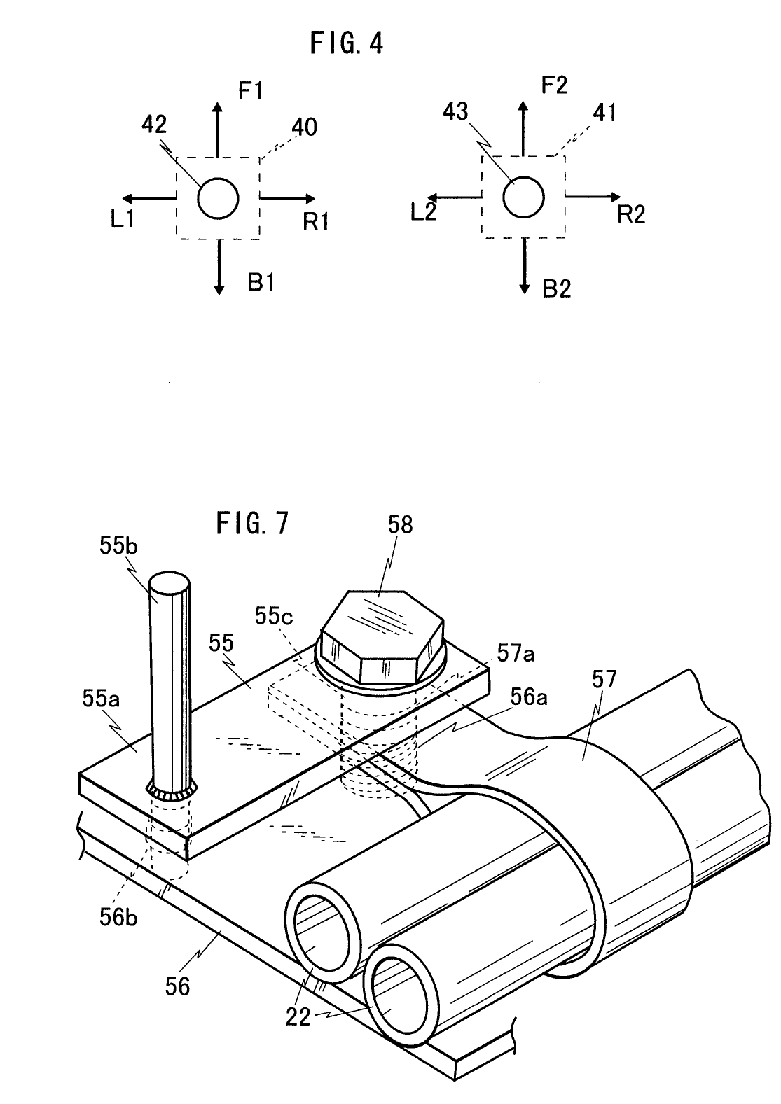

FIG. 3 is a hydraulic circuit diagram of the operational pattern switching valve 24, whereas FIG. 4 illustrates the operation lever devices installed on the left side and the right side of the operator's seat. In FIG. 3, reference numeral 27 indicates an arm cylinder, reference numeral 28 indicates a revolving motor, reference numeral 29 indicates an arm cylinder and reference numeral 30 indicates a bucket cylinder. Reference numerals 31 and 32 indicate main pumps from which the hydraulic fluid is supplied to the actuators 27˜30, reference numeral 33 indicates a pilot pump and reference numerals 34˜37 indicates control valves via which switching control for the hydraulic fluid supply from the main pump 31 or 32 to the actuators 27˜30 is achieved. The control valves 27˜30 are included in the control valve device 8. Reference number 38 indicates a gate lock valve that prevents engagement of the actuators 27˜30 during downtime.

Reference numeral 40 indicates a left-side operation lever device, whereas reference numeral 41 indicates a right-side operation lever device. As shown in FIG. 4, the operation lever devices 40 and 41 respectively include an operation lever 42 and an operation lever 43 installed to the left and to the right of the operator's seat. The operation lever 42 can be operated along the forward direction F1, the backward direction B1, the rightward direction R1 and the leftward direction L1, whereas the operation lever 43 can be operated along the forward direction F2, the backward direction B2, the rightward direction R2, and the leftward direction L2. The left-side and right-side operation lever devices 40 and 41 respectively include four pilot valves 44˜47 and four pilot valves 48˜51. A secondary port of each of the pilot valves 44˜51 is connected to a port present on one side of the operational pattern switching valve 24 via the corresponding hydraulic hose 25. Operation chambers 34a and 34b˜37a and 37b of the control valves 34˜37 are connected to the corresponding ports present on the other side of the operational pattern switching valve 24 via the hydraulic hoses 25.

The operational pattern switching valve 24 can be set to a specific position among positions A˜D in response to an operation of the operation lever 24a. For instance, when the operational pattern switching valve is set at position A, as shown in the figure, the arm cylinder 27 is caused to contract or extend as the left-side operation lever 42 is operated along the forward direction F1 or along the backward direction B1 and the revolving motor 28 is caused to revolve to the right or to the left as the left-side operation lever 42 is operated along the rightward direction R1 or along the leftward direction L1. In addition, the boom cylinder 29 is caused to contract or extend as the right-side operation lever 43 is operated along the forward direction F2 or along the backward direction B2 and the bucket cylinder 30 is caused to contract or extend as the right-side operation lever 43 is operated along the rightward direction R2 or along the leftward direction L2. If, on the other hand, the operational pattern switching valve 24 is set to position B, the revolving motor 28 is caused to revolve to the right or to the left as the left-side operation lever 42 is operated along the forward direction F1 or along the backward direction B1 and the arm cylinder 27 is caused to contract or extend as the left-side operation lever 42 is operated along the rightward direction R1 or along the leftward direction L1. The operational pattern assumed in conjunction with the right-side operation lever 43 is identical to the operational pattern assumed at position A. Thus, by selecting a specific position among positions A through D for the operational pattern switching valve 24, the operational pattern defining which of the operation levers 42 and 43 is used to operate a specific actuator among the actuators 27˜30 along a specific direction, to which the operator is most accustomed, can be set.

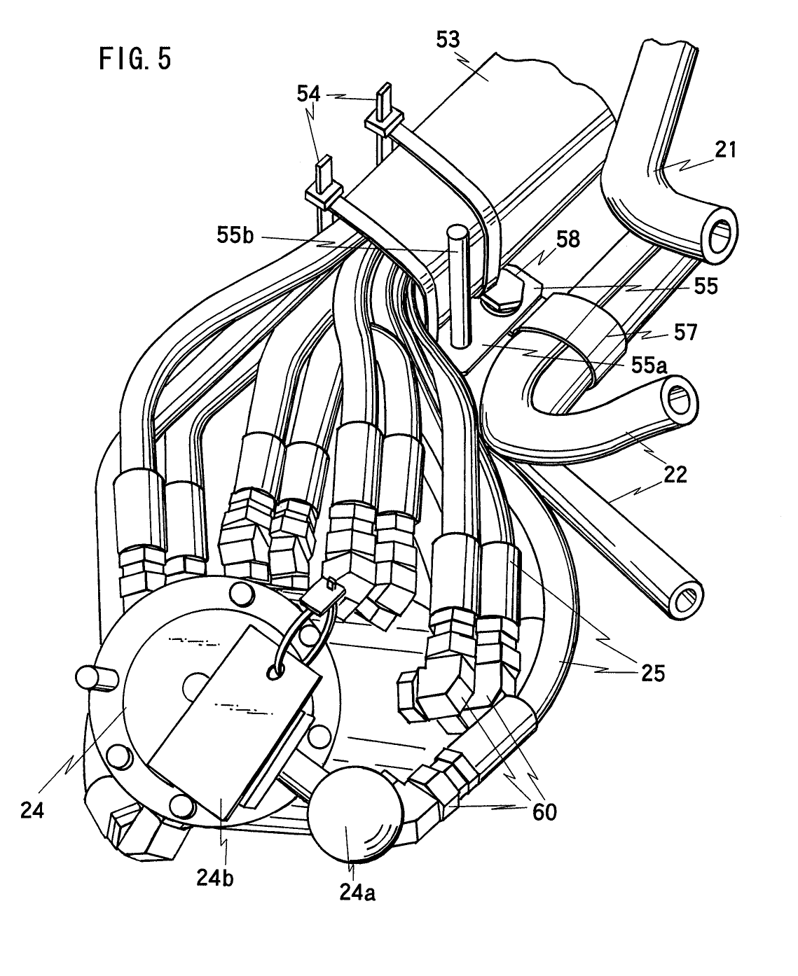

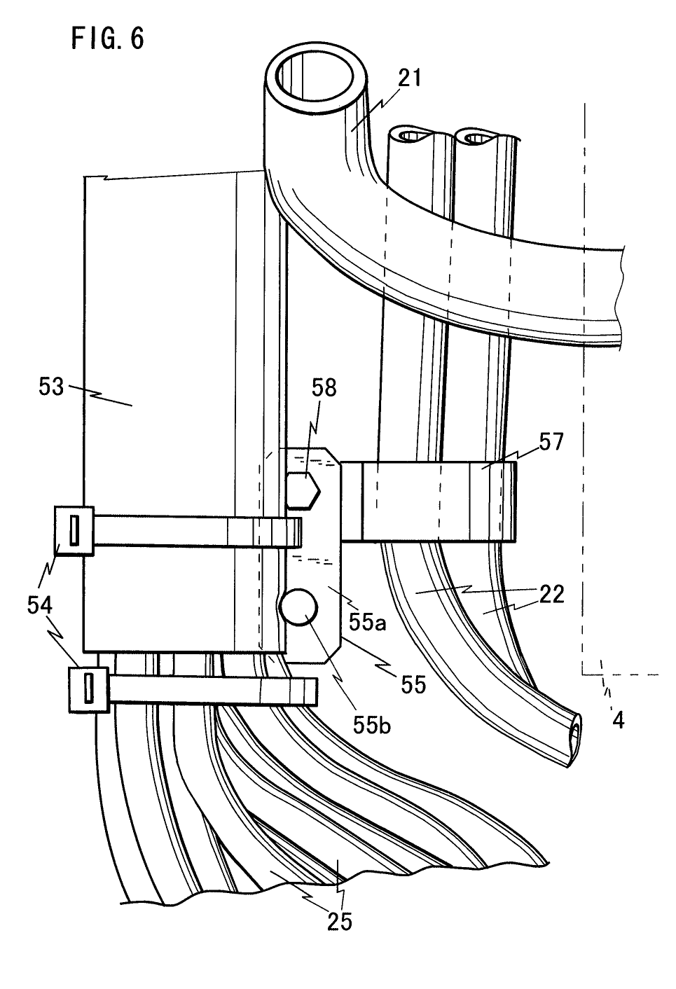

FIG. 5 is a perspective showing the layout of the hydraulic hoses 25 and the like disposed around the operational pattern switching valve 24, and FIG. 6 is a plan view showing part of the layout. In FIGS. 5 and 6, the hydraulic hoses 25, already connected via joints 60 to the operational pattern switching valve 24, are protected by a cover 53, which is tightened with bands 54. Reference numeral 55 indicates a guide member used to guide the hydraulic hoses 25. The guide member 55 is constituted with a plate 55a and a round rod 55b passing through the plate 55a and welded onto the plate 55a.

FIG. 7 is a perspective showing how the guide member 55 is mounted. Reference numeral 56 indicates a frame fixed onto the upper revolving superstructure 1 and reference numeral 57 indicates a clip locking the fuel hoses 22 to the frame 56. The clip 57 encircling the fuel hoses 22, locks the fuel hoses 22 onto the frame 56 as a mounting bolt 58 is inserted through a hole 57a formed in the clip 57 and the mounting bolt 58 is then threaded through a screw hole 56a formed at the frame 56.

In the embodiment, the mounting bolt 58 is inserted through a bolt insertion hole 55c formed at the plate 55a of the guide member 55 so as to block the guide member 55 together with the clip 57 onto the frame 56. In addition, the lower portion of the rod 55b is inserted through a hole 56b formed in the frame 56 so as to prevent rotation of the guide member 55, which may be caused by a load applied by the hydraulic hoses 25.

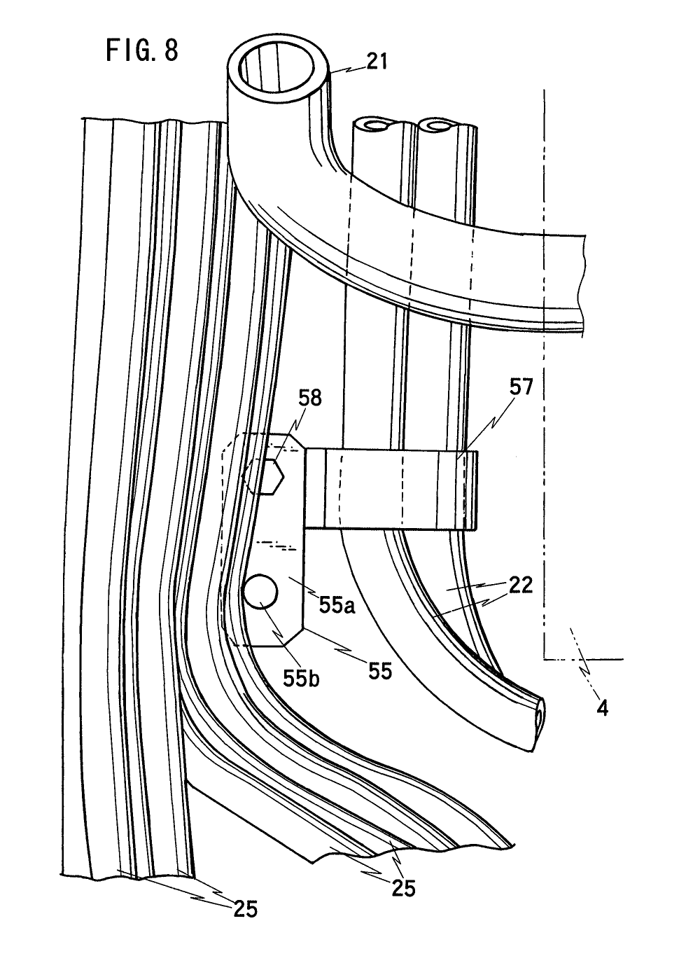

The hydraulic hoses 25 are connected to the operational pattern switching valve 24 without restricting the hydraulic hoses 25 with the cover 53 or the bands 54, as shown in FIG. 8, so as to ensure that the hydraulic hoses 25 can be maneuvered freely. When connecting the hydraulic hoses 25, the hydraulic hoses 25 are kept neatly in place by setting the portions of the hydraulic hoses 25 further toward the cooler chamber 4 in contact with the rod 55b of the guide member 55, which is mounted at the frame 56 together with the clip 57 via the mounting bolt 58, so as to ensure that no stray hydraulic hose 25 shifts toward the cooler chamber 4.

As explained above, the guide member 55 disposed between the cooler chamber 4 and the operator's cab 5 holds the hydraulic hoses 25 neatly in place so as to prevent any displacement of the hydraulic hoses 25 to be connected to the operational pattern switching valve 24 toward the cooler chamber 4. Consequently, none of the hydraulic hoses 25 being connected to the operational pattern switching valve 24 is allowed to shift out of the neatly aligned placement or become caught between the two hydraulic fluid pipings 21 and 21, or between a hydraulic fluid piping 21 and the cooler chamber 4. Thus, the hydraulic hoses 25 can be connected to the operational pattern switching valve 24 with ease and accuracy. Furthermore, since the operator does not need to hold the hydraulic hoses 25 to ensure that they do not shift out of alignment, better operational efficiency is assured.

In addition, the mounting bolt 58 at the clip 57, which locks the fuel hoses 22 onto the frame 50 disposed on the upper revolving superstructure 1, is used to attach the guide member 55 to the frame 56 in the embodiment, eliminating the need for another bolt to mount the guide member 55 and thus minimizing the number of required parts and the installation space. Moreover, since the guide member 55 is mounted together with the fuel hoses 22, the mounting process is simplified. Since rotation of the guide member 55 is prevented by inserting the lower portion of the rod 55b through the hole 56b formed in the frame 56, the guide member 55 is reliably locked onto the frame 56.

1. A hydraulic hose guiding device in a construction machine having an operational pattern switching valve, operation chambers for control valves used to control a plurality of hydraulic actuators, and pilot valves operated via operation levers installed on a left side and a right side of an operator's seat, which are connected through a plurality of hydraulic hoses installed between an operator's cab disposed on an upper revolving superstructure and a cooler chamber in a hydraulic power unit, characterized in that:
a guide member, used to keep said plurality of hydraulic hoses neatly in place by preventing said hydraulic hoses from shifting close toward said cooler chamber, is disposed between said operator's cab and said cooler chamber.

2. A hydraulic hose guiding device according to claim 1 characterized in that:
said guide member is constituted with a plate having a bolt through hole formed therein and a hydraulic hose guide rod passing through and locked onto said plate; and
said guide member is held fast so as not to turn loosely by attaching said plate via mounting bolts onto a frame present on said upper revolving superstructure and inserting a lower portion of said rod through a hole formed in said frame.
